(19) United States
(12) Patent Application Publication
(10) Pub. No.: US 2018/0334320 A1
(43) Pub. Date: Nov. 22, 2018

(54) INFUSED BEVERAGE SYSTEM, APPARATUS, AND METHOD OF MAKING AND USING SAME

(71) Applicant: THE MARKETING STORE WORLDWIDE, LP, Chicago, IL (US)

(72) Inventors: RUBEN RAMOS, ST. CHARLES, IL (US); TOM HARVAT, DARIEN, IL (US); TOM BROSSEAU, SCHAUMBURG, IL (US)

(21) Appl. No.: 15/983,876

(22) Filed: May 18, 2018

Related U.S. Application Data
(60) Provisional application No. 62/508,428, filed on May 19, 2017.

(51) Int. Cl. B65D 85/816; A23L 2/52; B65D 53/08; B65D 51/28; A47G 19/22

(52) U.S. Cl. CPC B65D 85/816; A23L 2/52; A23V 2002/00; B65D 51/28; A47G 19/2211; B65D 53/08

(57) ABSTRACT

A flavor infused beverage system and method. The system is a cup having a container configured to hold a flavor component. A first filter layer has a plurality of holes extending therethrough and is configured to cover an end of the container. A removable seal layer is configured to cover the first filter layer such that the interior portion of the container is sealed by the removable seal layer covering the first filter layer. A liquid can be inserted into the cup such that the liquid passes through the filter layer and contacts the flavor component.

### CROSS-REFERENCE TO RELATED APPLICATION

This application claims the benefit under 35 U.S.C. § 119(e) of the earlier filing date of U.S. Provisional Patent Application No. 62/508,428 filed on May 19, 2017, the disclosure of which is incorporated by reference herein.

### BACKGROUND

The present invention relates generally to beverage containers, and more particularly to a self-contained, infused, beverage system, apparatus and/or method of making or using same. It is desirable to create a convenient way to make infused beverages.

### SUMMARY

In one embodiment, the present disclosure is generally directed to a self-contained, infused, beverage system, apparatus and/or method. More particularly, in one embodiment, the system can includes a cup having a container configured to hold a flavor component. A first filter layer has a plurality of holes extending therethrough and is configured to cover an end of the container. A removable seal layer is configured to cover the first filter layer such that the interior portion of the container is sealed by the removable seal layer covering the first filter layer. A liquid can be inserted into the cup such that the liquid passes through the filter layer and contacts the flavor component. The presently disclosed technology includes the above-described concept in a variety of cups and lid configurations. The presently disclosed technology provides a quick, efficient and/or inexpensive way to create a specialty or flavored beverage. It is a convenient way to make fresh flavored beverages especially when traveling or on the go.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown. In the drawings:

FIG. 1 is a perspective view of one embodiment of the presently disclosed technology;

FIG. 2 is another perspective view thereof in use;

FIG. 3 is an exploded view of another embodiment;

FIGS. 4A, 4B and 4C is a schematic representation of the method of using the embodiment of FIG. 3;

FIG. 5 is a partially exploded perspective view of yet another embodiment of the presently disclosed technology;

FIG. 6 is a perspective view of the combination shown in FIG. 5;

FIGS. 7A, 7B, 7C, 7D and 7E are a schematic representation of the method of using another embodiment;

FIG. 8 is a perspective view of still another embodiment of the presently disclosed technology;

FIG. 9 is another perspective view thereof;

FIG. 10 is another side elevation view thereof, wherein one or more portions are shown as at least partially transparent for clarity;

FIG. 11 is a perspective view of yet another embodiment of the presently disclosed technology;

FIG. 12 is a perspective view of an embodiment of the presently disclosed technology;

FIG. 13 is a perspective view of yet another embodiment of the presently disclosed technology;

FIG. 14 is a perspective view of yet another embodiment of the presently disclosed technology;

FIG. 15 is a perspective view of yet another embodiment of the presently disclosed technology; and

FIG. 16 is a perspective view of yet another embodiment of the presently disclosed technology.

### DETAILED DESCRIPTION

Certain terminology is used in the following description for convenience only and is not limiting. The words “bottom,” “top,” “left,” “right,” “lower” and “upper” designate directions in the drawings to which reference is made. Unless specifically set forth herein, the terms “a,” “an” and “the” are not limited to one element but instead should be read as meaning “at least one.” The terminology includes the words noted above, derivatives thereof and words of similar import.

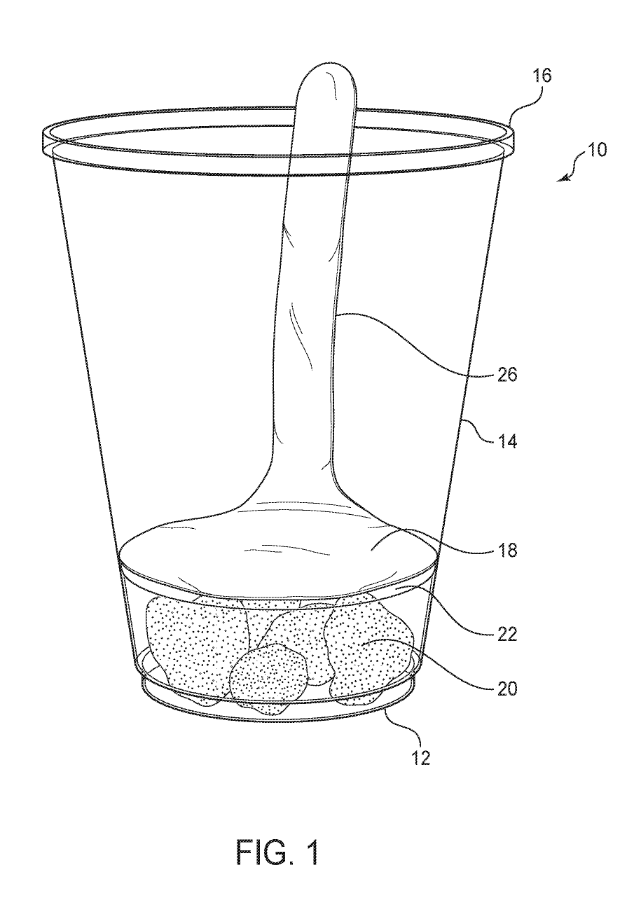

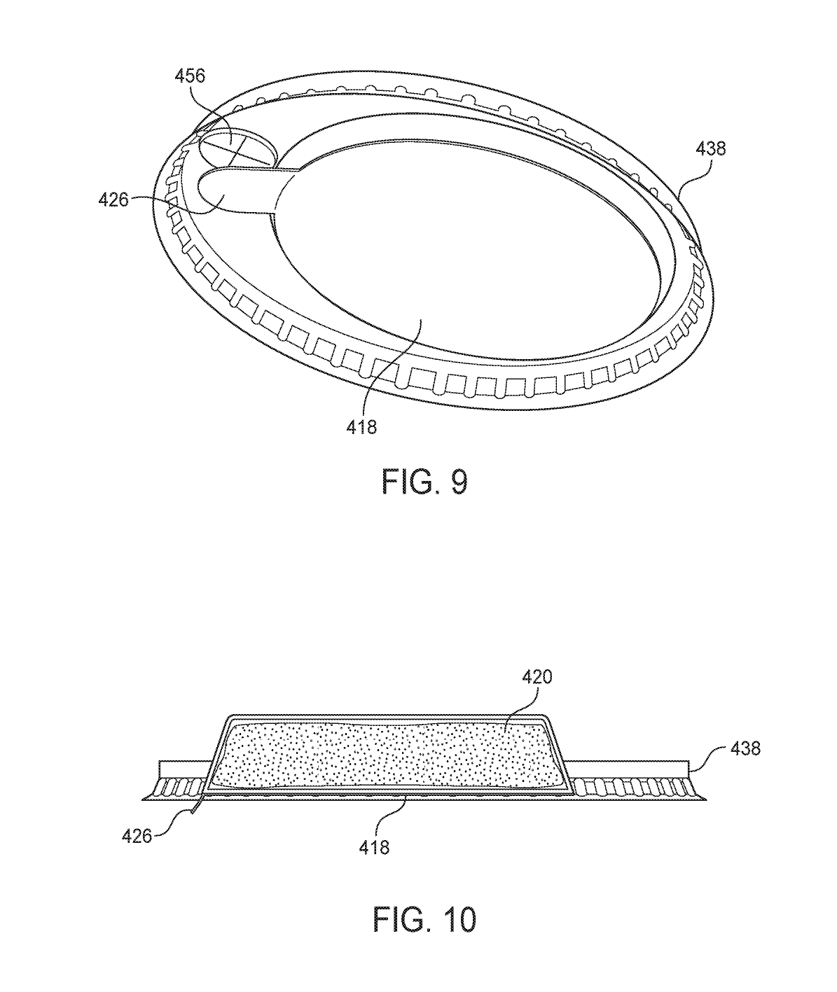

Referring to the drawings in detail, like numerals and those increased by multiples of one hundred in alternative embodiments indicate like elements found throughout. FIGS. 1-16 illustrate a system, apparatus, combination and method that can be used to create a single use (e.g. disposable) or reusable, flavored beverage including by adding liquid following removal of a freshness seal and through at least one filter. The liquid can be plain water, tea, carbonated water, or the like.

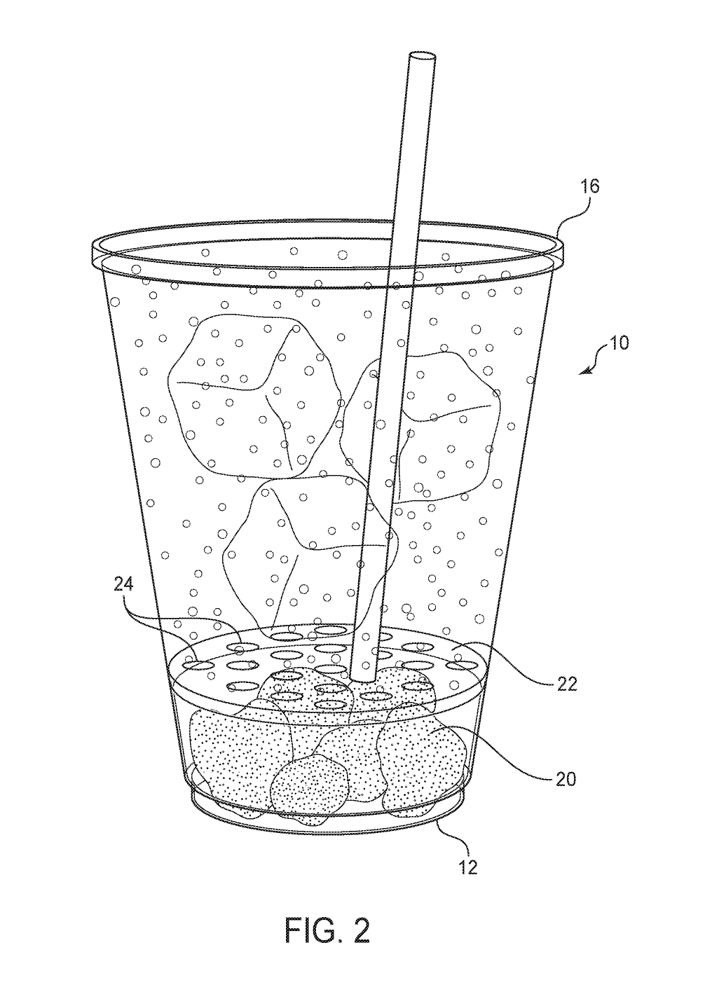

As shown in FIGS. 1-2, in one embodiment, the system can include a cup 10 having a bottom surface 12, a sidewall 14, and a rim 16 at an upper end thereof. The system can further include a removable first separation layer or removable seal layer 18, which provides an air and moisture seal such as foil or plastic, and, for example, a flavor component 20, which can be, for example, dried foodstuff like a lemon slice, berries or tea leaves, for example, and a second separation layer 22, which can be a filter, screen or a plate with a plurality of spaced-apart holes 24 extending therethrough. The second separation layer/filter layer 22 can be permanently fixed to or integrally formed with the cup 10.

A flavored beverage can be created by combining liquid through the filter layer 22 into the flavor component 20, and wherein freshness of the flavor component 20 is maintained by the removable seal layer 18. Additional separation layers can also be used, as is evidence from the attached drawings. In one embodiment, the foodstuff can be rehydrated or freeze-dried. In another embodiment, the foodstuff can be natural or artificially flavored material.

In one embodiment, the removable seal layer 18, the flavor component 20 and the filter layer 22 can be originally or initially contained in the cup 10 for single use. In other words, a user can purchase the cup 10 with the removable seal layer 18, the flavor component 20 and the filter layer 22 included and in the configuration shown and described herein. The removable seal layer 18 may include an elongated pull tab 26 which extends upwardly and is configured to be able to be grasped by a user to enable removal of the removable seal layer 18 from the filter. Pull tab 26 may extend past the rim 16 of the cup for ease of grasping. In use, as shown in FIG. 2, the removable seal layer 18 can be removed from the cup 10, and the filter layer 22 can allow the liquid or beverage to be flavored by permitting the liquid or beverage to flow through the filter layer 22 and contact the flavor component 20. Thus, the beverage or liquid is infused with the flavor and aroma of the flavor component 20. Meanwhile, the filter layer 18 can hold the flavor component 20 in place (e.g., toward a bottom of the cup 10). A straw 28 may be used to consume the flavored beverage.

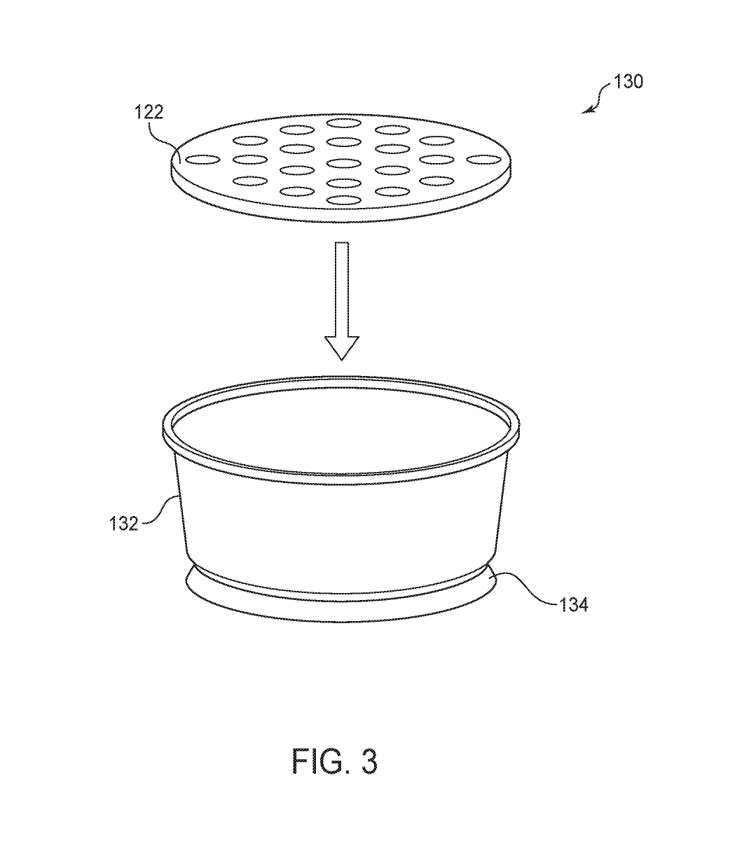

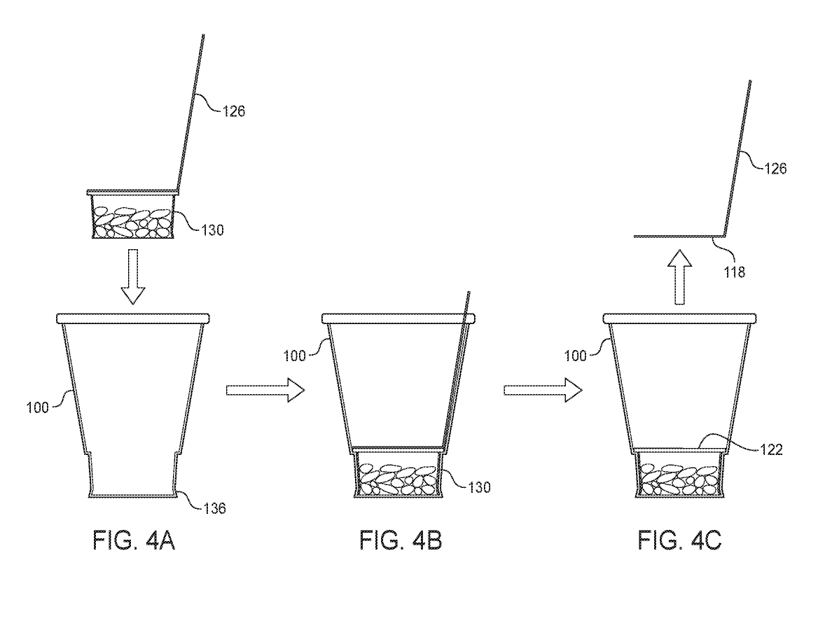

In one embodiment, as illustrated in FIGS. 3-4C, a flavor pod 130 (FIG. 3) is insertable into a cup 100, for example, a standard disposable drinking cup 100. The flavor pod 130 includes a container 132 configured to hold the flavor component 120. The container 132 may be substantially cylindrical or frusto-conical shaped to fit into the bottom portion of the cup 100. The open top of the container includes a filter 122 covered by a removable seal layer 118 having an elongated pull tab 126 as discussed above. The bottom of the container 132 may include a snap-retention feature 134 such as an annular molded groove which is lockable with a compatible feature 136 on the interior of the bottom portion of cup 100. The compatible feature 136 may be an annular inwardly projecting ridge on the bottom edge of the cup 100, such as a ridge provided on the bottom edge of a disposable cup to provide structural integrity. As shown In FIGS. 4A-4C, a sealed flavor pod 130 is inserted into the cup 100 (FIG. 4A). The snap-retention feature 134 of the sealed flavor pod 130 is snap-fitted or locked into the compatible feature 36 on the interior of the bottom portion of the cup 100 (FIG. 4B). The removable seal layer 118 is removed by pulling on the elongated pull tab 126 and discarded (FIG. 4C). A liquid such as water or tea is added to the cup and reaches the flavor component 120 in the container 132 to flavor the liquid. The flavor pod 130 allows for smaller and more economical stock-keeping and storage of many different types of dried fruits and other dried flavorings or infusible materials. And the flavor pod 130 can be used with standard ‘compatible’ disposable drinking cups, eliminating the need for an additional cup stock keeping unit (SKU), allowing further flexibility for the implementation for offering the dried fruit as a beverage choice.

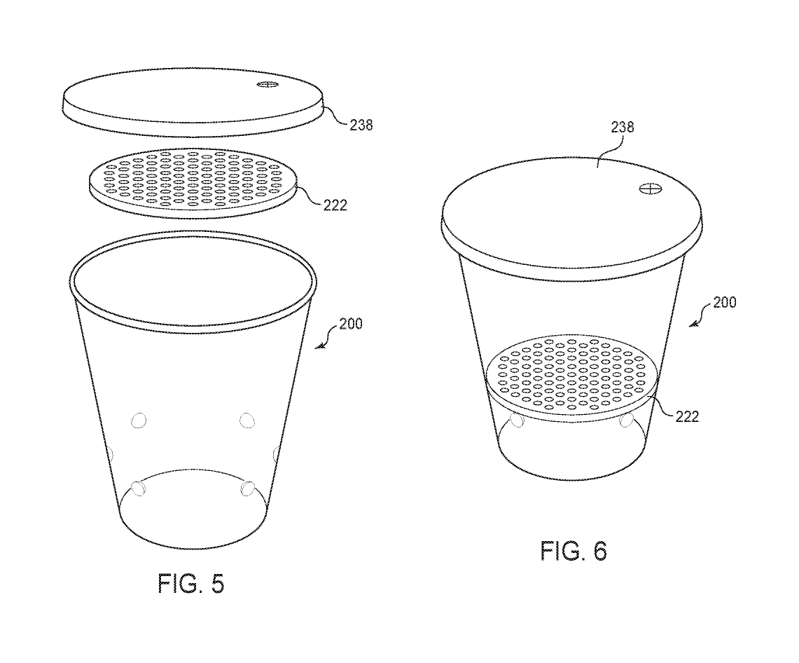

As shown in FIGS. 5 and 6, the technology of one embodiment can be directed to a re-useable infusible beverage system. This can be an at-home or at-work cup 200 with an additive screen or filter that allows a person to add their own fruit or other flavor sources and then place a screen or filter layer 222 to trap these to allow the liquid to mix with the infused flavors—and not allow drinking of large pieces of the fruit or other additive materials. The infusion screen or filter layer 222 can be removable for applying flavors, etc. and for cleaning. The user could add their own flavors. The cup 200 may also include a lid 238 so that the flavor components (not shown) may be stored in the cup 200 until ready to be used.

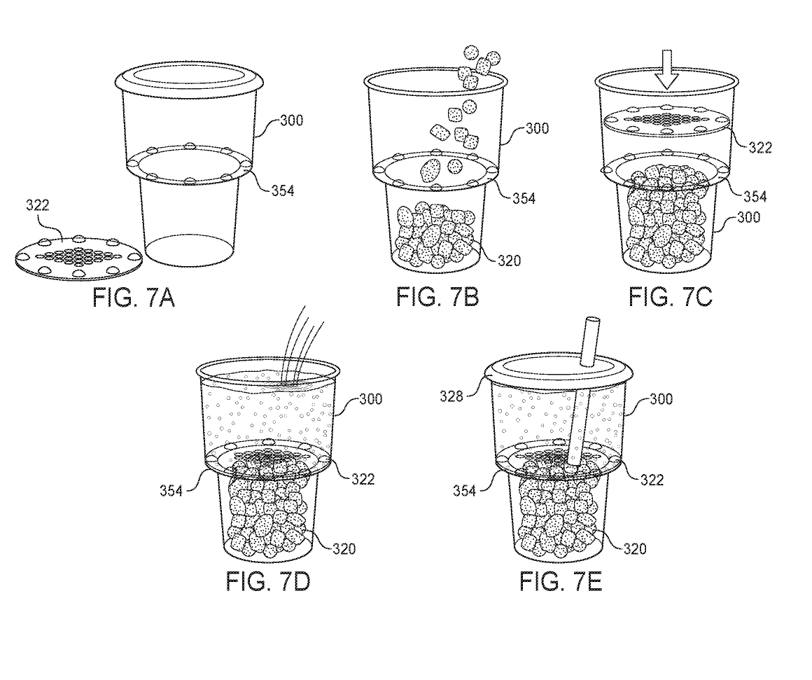

As shown in FIGS. 7A-7E, a method of using a cup with a removable filter layer 322 is shown. The filter layer 322 is removed from the cup 300 (FIG. 7A). A flavor component 320 such as dried fruit are added to the cup 300 (FIG. 7B). The filter layer 322 is reinserted into the cup 300. (FIG. 7C). Cup 300 may include a ledge 354 on an interior surface thereof, the ledge 354 being positioned between the bottom surface and the upper end, wherein at least a portion of filter layer 322 is configured to rest on the ledge 354. The filter layer 322 and ledge 354 may include cooperating locking features to keep filter layer 322 in place. A liquid such as water or tea is added to the cup 300 and reaches the flavor component 320 in the cup 300 to flavor the liquid (FIG. 7D). A straw 328 may be inserted so that the flavored beverage may be consumed (FIG. 7E).

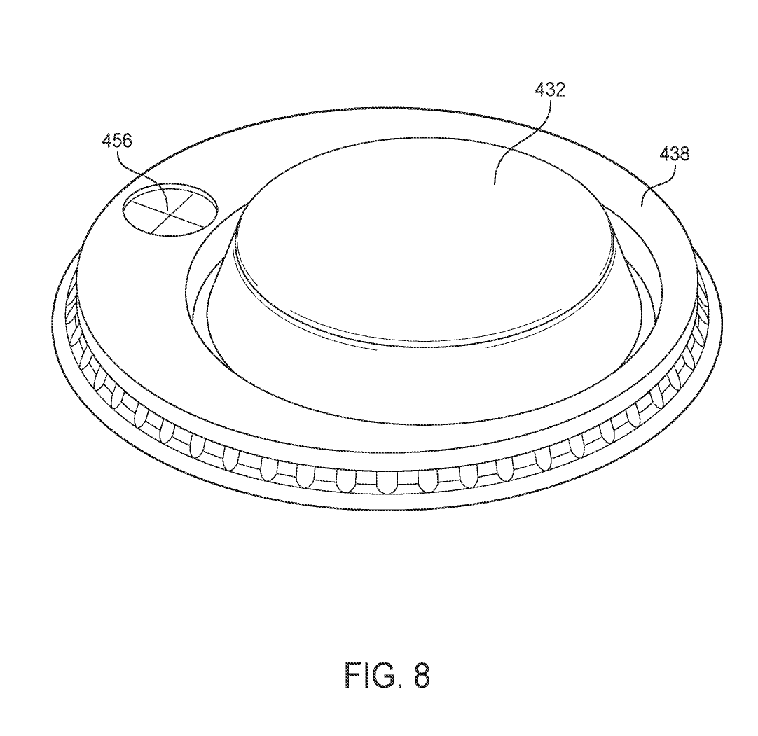

In one embodiment, as illustrated in FIGS. 8-10, the above-described features can be included in a lid 438 of a cup, instead of in the cup. For example, the lid 438 can contain a raised container compartment 432 for the flavor component 420. The lid 438 further includes the removable seal layer 418 having a pull tab 426 on an underside of the lid 438 covering the container 432 compartment 432. In one embodiment, the removable seal layer 418 can be removed and/or separated from the flavor component 420 and/or a remainder of the lid 438. When the removable seal layer 418 is removed from the flavor component 420 and/or a remainder of the lid 420, the flavor component 420 can fall into a cup. In another embodiment, the flavor component 420 can be sealed within the lid 438 until use or until the user wishes to consume a beverage. For example, pressure or a force applied to a portion of the removable lid 438 at least partially removes or causes the flavor component 420 to pierce the removable seal layer 418 such that the flavor component moves from the removable lid 438 into the cup. The lid 438 may further include a filter layer (not shown). The lid 438 may further include a perforation 456 configured to receive at least a portion of a straw therethrough.

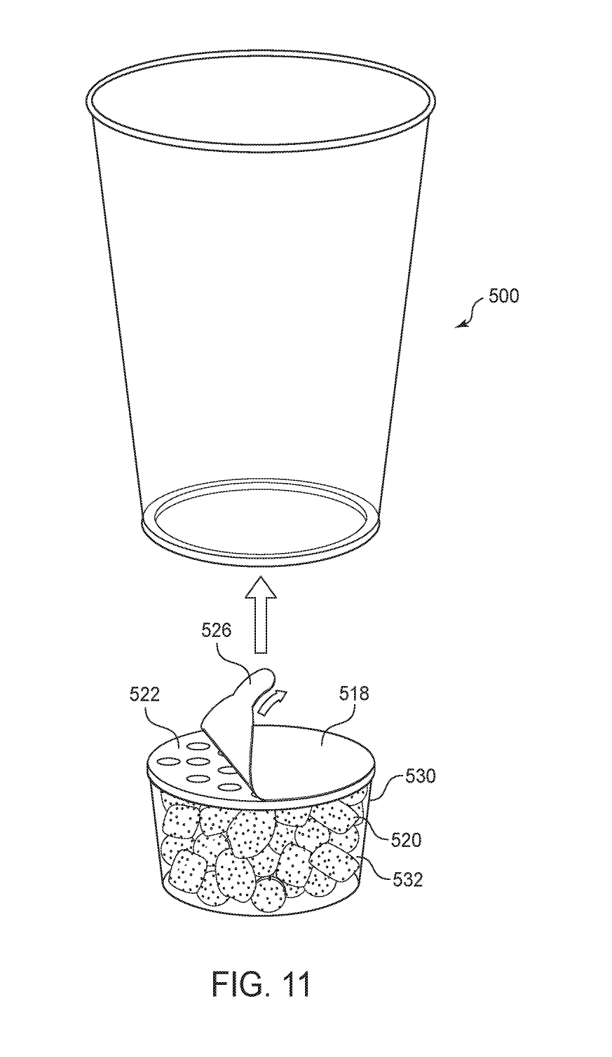

In one embodiment, as illustrated in FIG. 11, the flavor component 520 and the filter 522 can be provided within a container 532 of a flavor pod 530 separate and distinct from a cup 500 having an open bottom 512. Once the removable seal layer 518 having pull tab 526 is removed, the flavor pod 530 can be physically placed in and/or attached (e.g., by a friction fit or screw threads) to the bottom 512 of cup 500, which allows the beverage to be flavored while being physically and visually separated from the flavored liquid.

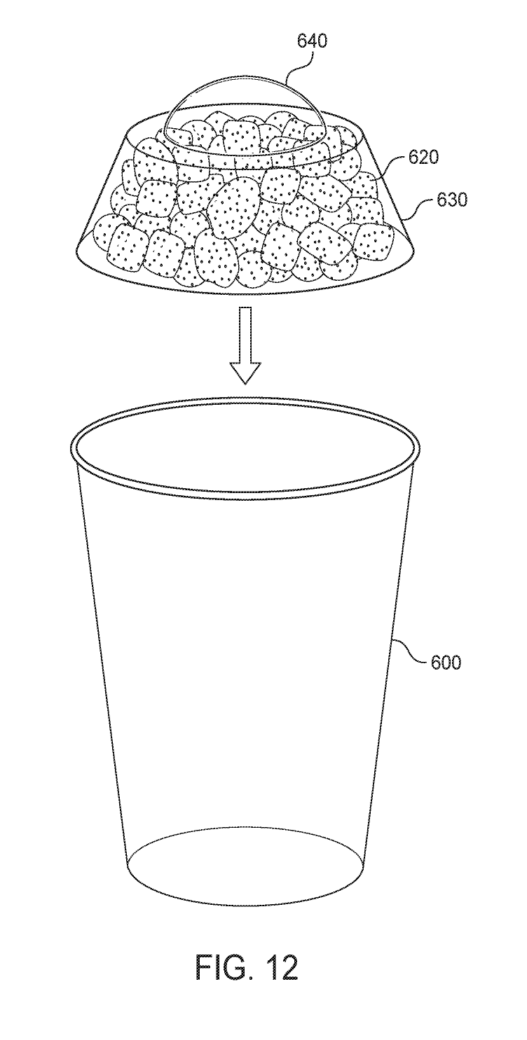

In one embodiment, as illustrated in FIG. 12, a flavor pod 630 with a press down feature 640 which, when inverted over the cup 600, allows the flavor component 620 to be released into the cup 600.

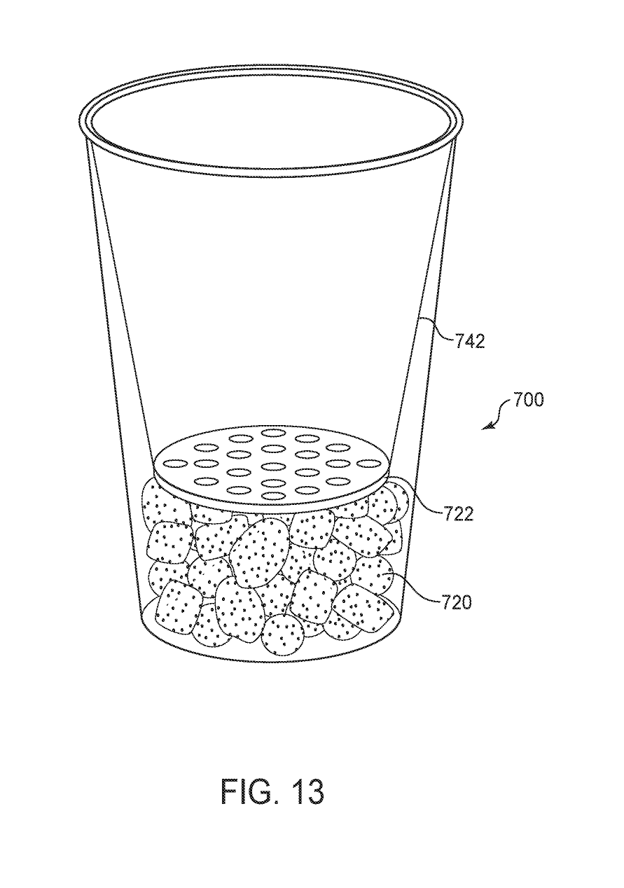

In one embodiment, as illustrated in FIG. 13, cup 700 may have an inner cup-like sleeve 742 having a filter 722 on the bottom thereof. The flavor component 720 is contained in the bottom of the cup 700 beneath the bottom of sleeve 742.

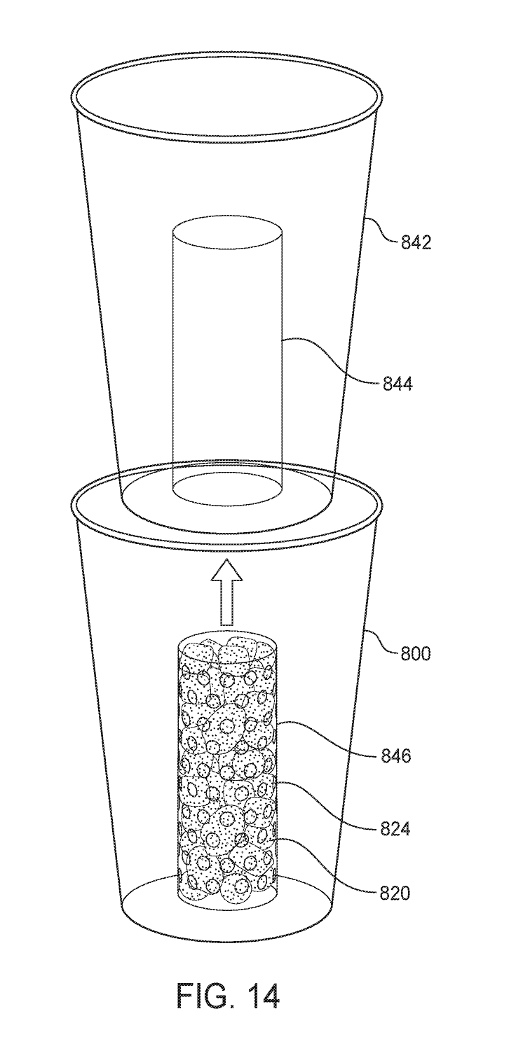

In one embodiment, as illustrated in FIG. 14, cup 800 has an inner sleeve 842 having a central cylindrical portion 844 extending upwardly from the base of the cup 800. Inner sleeve 842 forms a disposable covering for the interior of cup 800 which also has a central cylindrical portion 846 extending upwardly from the base of cup 800. Cylindrical portion 846 includes filter holes 824 and forms a container for flavor components 820.

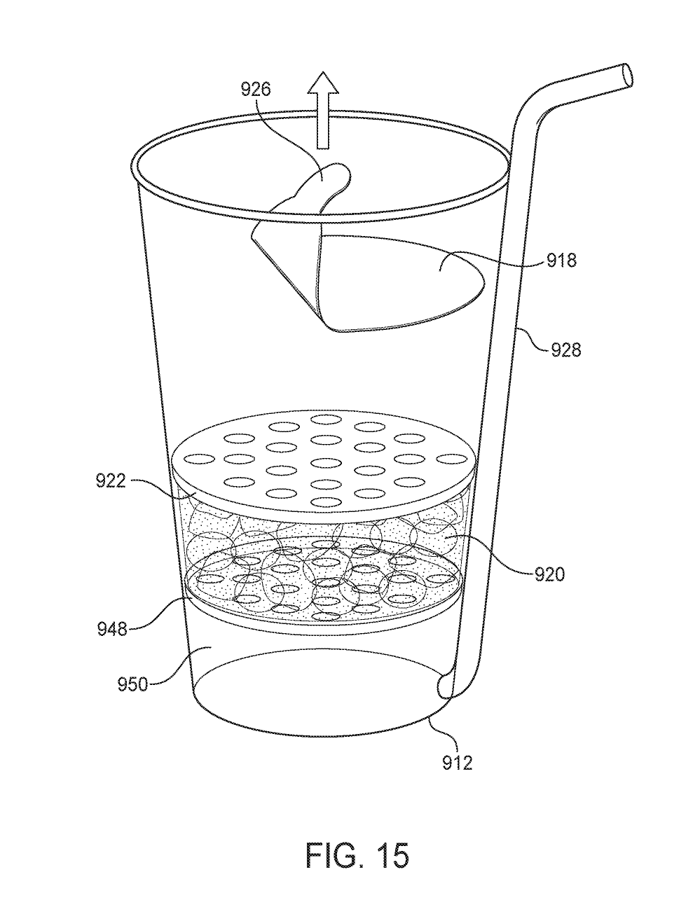

In one embodiment, as illustrated in FIG. 15, a cup 900 has an upper filter 922 and a lower filter 948 with a flavor component 920 contained there between. Lower filter 948 is spaced above the bottom 912 of cup 900. Upper filter 922 is covered by removable seal layer 918 with pull tab 926. Cup 900 may include an integral straw 928 which may extend to the space 950 between the lower filter 948 and the bottom 912 of cup 900.

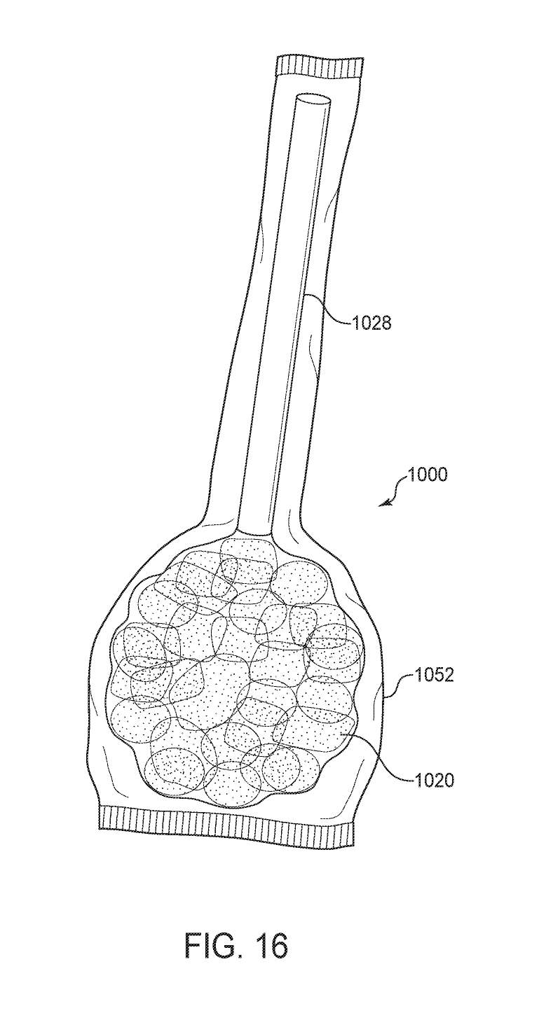

In yet a further embodiment, FIG. 16 shows a flavor bag 1000 for containing a flavor component 1020. As shown, flavor bag 1000 may be disposed in a disposable bag 1052 and may have an integral straw 1028. Flavor bag 1000 may be mesh or plastic with filter holes.

It will be appreciated by those in the art that one embodiment of the presently disclosed invention may eliminate the need to strain flavoring from a liquid to obtain a single use flavored beverage. It will be appreciated by those in the art that the present invention may provide for an opportunity to produce a single use flavored beverage using naturally ingredients which maintain freshness. One potential benefit of certain embodiments of the presently disclosed technology is the prevention of floating fruit bodies, regardless of size, texture, pliability etc. from creating any type of obstruction during the drinking process, regardless if the beverage is consumed by straw or direct mouth to vessel operation. This is one reason why there in certain embodiments there is a separator screen (gauge can be sized as desired) to keep the fruit bodies clearly physically and visually defined away from consumption in during normal circumstances.

In certain embodiments, to provide for the dried fruit freshness, the seal component (foil as one option) exists to maintain freshness during the start of the packing process until this cup is ready to be used. In one embodiment, this is the only seal needed to be removed before using. In one embodiment, the pull tab makes operation consistently easy for a crew member to prepare this cup with liquid (such as water) without ever touching the fruit itself. Or, multiple cups can be purchased by the customer for convenience and later use. The presently disclosed technology can be activated easily by anyone (e.g., worker or customer). The fruit itself can be guaranteed fresh, natural, organic and/or healthy. Ice can be added by the worker or customer. Tea can be infused, as opposed to fruit, if a different taste is desired.

In one embodiment, the presently disclosed technology is a convenient way to make fresh flavored beverages when traveling or on the go. Purchase the product, add liquid of your choice, for example, water, etc. and the flavors in the cup base (dried fruit, etc.) mix with the water to create a flavored beverage. The embodiment could be a single use (e.g., disposable) customer prepped item, or a crew/worker-activated beverage. The product could also be sold in multi packs at retail outlets as an on the go picnic or party pack. The flavor material can be trapped teas, infusible vitamin materials, and/or other health or therapeutic, homeopathic beneficial consumables.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims. The presently disclosed technology includes the combination of any of the elements disclosed in discrete claims below.

I/We claim:

1. A system comprising:
a cup having a bottom surface, a sidewall extending upwardly therefrom, and a rim at an upper end thereof;
a container portion, wherein the container portion has a first open end and has an interior portion configured to hold a flavor component;
a first filter layer having a plurality of holes extending therethrough, wherein the first filter layer is configured to cover the first open end of the container portion;
a removable seal layer configured to cover the first filter layer, wherein the interior portion of the container portion is sealed by the removable seal layer covering the first filter layer.

2. The system of claim 1, wherein the flavor component is dried foodstuff.

3. The system of claim 1, wherein the removable seal layer includes a pull tab configured to be grasped by a user to remove the removable seal layer, and wherein the pull tab is configured to extend past the rim of the cup.

4. The system of claim 1, wherein the removable seal layer is made of foil or plastic.

5. The system of claim 1, wherein the container portion is integrally formed with the cup.

6. The system of claim 5, wherein the cup includes a ledge on an interior surface of the sidewall, the ledge being positioned between the bottom surface and the rim, wherein at least a portion of the filter first layer is configured to rest on the ledge and be locked thereto.

7. The system of claim 1, wherein the container portion has a second open end spaced from the bottom surface of the cup, and wherein a second filter layer covers the second open end.

8. The system of claim 1, wherein the container portion is configured to be removable from the cup.

9. The system of claim 8, wherein the container portion is shaped to fit into a bottom portion of the cup, and wherein the container portion has a snap-retention feature configured to snap fit with a compatible feature on an interior surface of a bottom portion of the sidewall of the cup.

10. The system of claim 9, wherein the removable seal layer includes a pull tab configured to be grasped by a user to remove the removable seal layer, and wherein the pull tab is configured to extend past the rim of the cup when the container portion is in the cup.

11. The system of claim 1, further comprising:
a removable lid configured to engage the rim of the cup to seal contents within the cup.

12. A system comprising:
a cup having a bottom surface, a sidewall extending upwardly therefrom, and a rim at an upper end thereof;
a container portion, wherein the container portion has a first open end and has an interior portion configured to hold a flavor component;
a removable seal layer configured to cover the first filter layer, wherein the interior portion of the container portion is sealed by the removable seal layer covering the first filter layer;
a removable lid configured to engage the rim of the cup to seal contents within the cup;
wherein the container portion is formed in the removable lid, wherein pressure or a force applied to a portion of the removable lid at least partially removes or causes the flavor component to pierce the removable seal layer such that the flavor component moves from the removable lid into the cup.

13. The system of claim 12, wherein the removable seal layer includes a pull tab configured to be grasped by a user to remove the removable seal layer.

14. The system of claim 13, wherein the removable lid further comprises a perforation configured to receive at least a portion of a straw therethrough.

15. A system comprising:
a first cup having a bottom surface, a sidewall extending upwardly therefrom, a rim at an upper end thereof, and a central column spaced inwardly from the sidewall, the central column containing a flavor component, the central column including one or more holes extending through a periphery thereof; and
a second cup complementing the first cup and being configured to fit at least partially within the first cup, the second cup including a bottom surface, a sidewall extending upwardly therefrom, a rim at an upper end thereof, and a central column spaced inwardly from the sidewall, wherein the second cup is configured to be removed from the first cup and liquid is inserted into the first cup to infuse the flavor component within the central column of the first cup.

16. A flavor pod comprising:
a container, wherein the container has a first open end and has an interior portion configured to hold a flavor component, and wherein the container is configured to be inserted into a cup;
a first filter layer having a plurality of holes extending therethrough, wherein the first filter layer is configured to cover the first open end of the container;
a removable seal layer configured to cover the first filter layer, wherein the interior portion of the container is sealed by the removable seal layer covering the first filter layer.

17. The flavor pod of claim 16, wherein the flavor component is dried foodstuff.

18. The flavor pod of claim 16, wherein the removable seal layer includes a pull tab configured to be grasped by a user to remove the removable seal layer, and wherein the pull tab is configured to extend past the rim of the cup.

19. The flavor pod of claim 16, wherein the removable seal layer is made of foil or plastic.

20. The flavor pod of claim 16, wherein the flavor pod has a snap-retention feature configured to snap fit with a compatible feature on an interior surface of the cup.

21. A method comprising:
removing a removable seal layer from the interior of a cup;
inserting liquid into the cup such that the liquid passes through a filter layer and contacts a flavor component located near a bottom surface of the cup.
